(19) United States
(12) Patent Application Publication
(10) Pub. No.: US 2025/0322809 A1
(43) Pub. Date: Oct. 16, 2025

(54) DISPLAY DEVICE

(71) Applicant: Magnolia White Corporation, Tokyo (JP)

(72) Inventor: Hitoshi TANAKA, Tokyo (JP)

(21) Appl. No.: 19/085,496

(22) Filed: Mar. 20, 2025

(30) Foreign Application Priority Data
Apr. 10, 2024 (JP) 2024-063587

(51) Int. Cl. G09G 3/36

(52) U.S. Cl. CPC G09G 3/3677; G09G 2310/0286; G09G 2310/08

(57) ABSTRACT

A display device includes: first pixels and second pixels arrayed in a first direction and arranged adjacent to each other in a second direction; first and second gate lines coupled to gates of pixel transistors of first and second pixels, respectively; a drive circuit to drive the pixel transistors of the first pixel and the second pixel via the first and the second gate lines, respectively; and a display region in which the first gate line, the pixel transistor of the first pixel, the second gate line, and the pixel transistor of the second pixel are arrayed in order in the second direction. Further, the drive circuit simultaneously turns on the pixel transistor of the first pixel and the pixel transistor of the second pixel, and then sequentially turns off the pixel transistor of the second pixel and the pixel transistor of the first pixel in order.

### CROSS-REFERENCE TO RELATED APPLICATION

This application claims the benefit of priority from Japanese Patent Application No. 2024-063587 filed on Apr. 10, 2024, the entire contents of which are incorporated herein by reference.

### BACKGROUND

The present disclosure relates to a display device.

In configurations that magnify displayed video by a lens, such as virtual reality (VR), augmented reality (AR), and mixed reality (MR), display panels have recently been required to have higher definition. Various configurations that achieve a high frame rate in such a high-definition panel are conventionally disclosed, including display devices that can simultaneously drive a plurality of pairs of adjacent gate lines (e.g., Japanese Patent Application Laid-open Publication No. 2010-271366).

In such display devices, not only holding capacitance formed between a pixel electrode and a common electrode but also parasitic capacitance is generated between the pixel electrode and other conductive members. As a result, a pixel electrode potential decreases due to charge redistribution in the holding capacitance in a gate-off state, which may compromise the accuracy of the displayed image. In particular, the holding capacitance decreases as the display has higher definition, and the effect of the gate-source parasitic capacitance in the pixel transistor relatively increases.

### SUMMARY

There is a need for providing a display device that can suppress deterioration in display quality due to charge redistribution in holding capacitance in a gate-off state.

According to an embodiment, a display device includes: a plurality of first pixels arrayed in a first direction; a plurality of second pixels arrayed in the first direction and adjacent to the respective first pixels in a second direction intersecting the first direction; a first gate line coupled to a gate of a pixel transistor of each of the first pixels; a second gate line coupled to a gate of a pixel transistor of each of the second pixels; a drive circuit configured to drive the pixel transistor of the first pixel via the first gate line and drive the pixel transistor of the second pixel via the second gate line; and a display region in which the first gate line, the pixel transistor of the first pixel, the second gate line, and the pixel transistor of the second pixel are arrayed in order in the second direction. Further, the drive circuit simultaneously turns on the pixel transistor of the first pixel and the pixel transistor of the second pixel, and then sequentially turns off the pixel transistor of the second pixel and the pixel transistor of the first pixel in order.

According to an embodiment, A display device includes: a plurality of first pixels arrayed in a first direction; a plurality of second pixels arrayed in the first direction and adjacent to the respective first pixels in a second direction intersecting the first direction; a plurality of third pixels arrayed in the first direction and adjacent to the respective second pixels in the second direction; a first gate line coupled to a gate of a pixel transistor of each of the first pixels; a second gate line coupled to a gate of a pixel transistor of each of the second pixels; a third gate line coupled to a gate of a pixel transistor of each of the third pixels; a drive circuit configured to drive the pixel transistor of the first pixel via the first gate line, drive the pixel transistor of the second pixel via the second gate line, and drive the pixel transistor of the third pixel via the third gate line; and a display region in which the first gate line, the pixel transistor of the first pixel, the second gate line, the pixel transistor of the second pixel, the third gate line, and the pixel transistor of the third pixel are arrayed in order in the second direction. Further, the drive circuit simultaneously turns on the pixel transistor of the first pixel, the pixel transistor of the second pixel, and the pixel transistor of the third pixel, and then sequentially turns off the pixel transistor of the third pixel, the pixel transistor of the second pixel, and the pixel transistor of the first pixel in order.

### BRIEF DESCRIPTION OF THE DRAWINGS

FIG. 1 is a diagram of an example of a schematic configuration of a display device according to an embodiment;

FIG. 2 is a diagram of an example of a pixel array in a display region;

FIG. 3 is a sectional view of a schematic sectional structure of the display device;

FIG. 4 is a block diagram of an example of the configuration of a gate driver;

FIG. 5 is a circuit diagram of an example of the circuit configuration of a shift register circuit;

FIG. 6 is a circuit diagram of an example of the circuit configuration of a gate line drive circuit;

FIG. 7 is a timing chart of a first example of gate line drive according to a first comparative example;

FIG. 8 is a timing chart of a second example of gate line drive according to the first comparative example;

FIG. 9 is a timing chart of an example of gate line drive according to a first embodiment;

FIG. 10 is a timing chart of a third example of gate line drive according to the first comparative example;

FIG. 11 is a timing chart of an example of gate line drive according to a modification of the first embodiment;

FIG. 12 is a timing chart of a first example of gate line drive according to a second comparative example;

FIG. 13 is a timing chart of a second example of gate line drive according to the second comparative example;

FIG. 14 is a timing chart of an example of gate line drive according to a second embodiment;

FIG. 15 is a timing chart of a third example of gate line drive according to the second comparative example; and

FIG. 16 is a timing chart of an example of gate line drive according to a modification of the second embodiment.

### DETAILED DESCRIPTION

In the configuration disclosed in the related art in a pixel adjacent to both the simultaneously driven gate lines, the parasitic capacitance generated between the pixel and each of the two adjacent gate lines affects the pixel electrode potential. In a pixel adjacent to one of the simultaneously driven gate lines, the parasitic capacitance generated between the pixel and the adjacent gate line affects the pixel electrode potential. This causes a potential difference in pixel electrode potential between the pixel adjacent to both the simultaneously driven gate lines and the pixel adjacent to one of the simultaneously driven gate lines in the pixel electrode potential between the two simultaneously driven gate lines. As a result, the display quality may possibly deteriorate.

Exemplary aspects (embodiments) to embody the present disclosure are described below in greater detail with reference to the accompanying drawings. The content described in the embodiment below is not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the disclosure and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

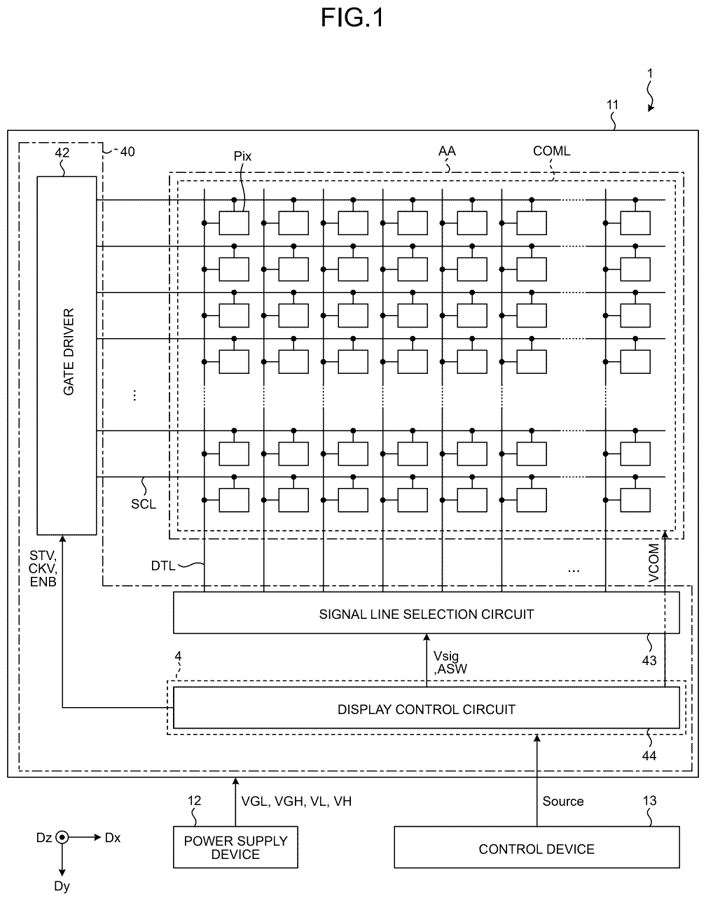

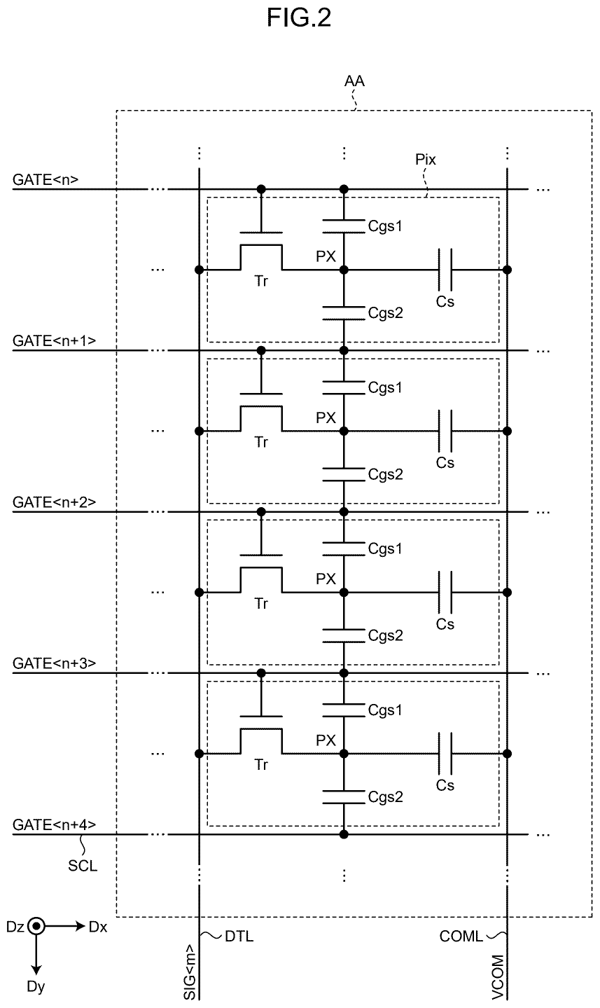

FIG. 1 is a diagram of an example of a schematic configuration of a display device according to an embodiment. FIG. 2 is a diagram of an example of a pixel array in a display region.

A display device 1 according to the present embodiment is, for example, a liquid crystal display device including liquid crystal display elements as display elements. The display device 1 according to the present disclosure can employ a driving method, such as a column inversion driving method and a frame inversion driving method. The driving method employed by the display device 1 is not limited to the column inversion driving method or the frame inversion driving method.

The display device 1 has a display region AA on a display panel 11 and includes a drive circuit 40 in the peripheral region of the display region AA. The display device 1 is supplied with electric power from a power supply device 12.

The drive circuit 40 includes a gate driver 42, a signal line selection circuit 43, and a display control circuit 44. The gate driver 42 and the signal line selection circuit 43 are thin-film transistor (TFT) circuits formed in the peripheral region of the display region AA. The display control circuit 44 is included in a driver IC 4 mounted in the peripheral region of the display region AA. The driver IC 4 is coupled to a control device 13 via a relay substrate composed of flexible printed circuits (FPC), for example.

The control device 13 controls power supply from the power supply device 12 to the display device 1. The control device 13 also controls power-on and -off of the display device 1. The power supply device 12 and the control device 13 are mounted on an apparatus (not illustrated) on which the display device 1 is mounted, for example.

The display region AA is provided with a plurality of pixels Pix arrayed in a Dx direction (first direction) and a Dy direction (second direction). The display region AA is also provided with gate lines SCL for supplying gate signals GATE to the pixels Pix, signal lines DTL for supplying pixel signals SIG to the pixels Pix, and a common electrode COML for supplying common potential VCOM to the pixels Pix. The gate line SCL according to the present embodiment is provided extending in the Dx direction. The signal line DTL according to the present embodiment is provided extending in the Dy direction.

As illustrated in FIG. 2, each pixel Pix includes a pixel transistor Tr and a pixel electrode PX. The pixel transistor Tr includes a thin-film transistor (TFT), or an n-channel metal oxide semiconductor (MOS) TFT (hereinafter also referred to as “n-type TFT”), for example. The source of the pixel transistor Tr is coupled to the signal line DTL, the gate thereof is coupled to the gate line SCL, and the drain thereof is coupled to the pixel electrode PX. Holding capacitance Cs is formed between the pixel electrode PX and the common electrode COML.

The gate signal GATE is supplied to the gates of the pixel transistors Tr of the pixels Pix arrayed in the Dx direction (first direction) via the gate line SCL, and the pixel signal SIG is supplied to the sources of the pixel transistors Tr of the pixels Pix arrayed in the Dy direction (second direction) via the signal line DTL.

In FIG. 2, the total number of pixels Pix arrayed in the Dx direction (first direction) is M, and the total number of pixels Pix arrayed in the Dy direction (second direction) is N. The gate signal GATE<n> is supplied to the gates of the pixel transistors Tr of the pixels Pix arrayed on the n-th row (n is a natural number from 1 to N) in the Dy direction (second direction). The gate signal GATE<n+1> is supplied to the gates of the pixel transistors Tr of the pixels Pix arrayed on the n+1-th row in the Dy direction (second direction). The gate signal GATE<n+2> is supplied to the gates of the pixel transistors Tr of the pixels Pix arrayed on the n+2-th row in the Dy direction (second direction). The gate signal GATE<n+3> is supplied to the gates of the pixel transistors Tr of the pixels Pix arrayed on the n+3-th row in the Dy direction (second direction).

The pixel signal SIG<m> is supplied to the sources of the pixel transistors Tr of the pixels Pix arrayed on the m-th column (m is a natural number from 1 to M) in the Dx direction (first direction).

The pixel Pix according to the present disclosure includes, for example, a red pixel for displaying red (R), a green pixel for displaying green (G), and a blue pixel for displaying blue (B). Alternatively, the pixel Pix may further include a white pixel for displaying white (W). The pixel array is a stripe array in which RGB(W) pixels are arrayed in the Dx direction (first direction), for example. The pixel array according to the present disclosure, however, simply needs to be a pixel array in which the display color of the pixels arrayed in the Dy direction (second direction) is the same color, and is not limited to the RGB(W) stripe array.

The power supply device 12 generates a negative first potential VGL and a positive second potential VGH and supplies them to the display device 1. The first potential VGL is −8 V, for example. The second potential VGH is +8 V, for example. The first potential VGL and the second potential VGH are supplied to the gate driver 42. The first potential VGL supplied to the gate driver 42 is not limited to −8 V. The second potential VGH supplied to the gate driver 42 is not limited to +8 V.

The power supply device 12 generates a negative third potential VL and a positive fourth potential VH and supplies them to the display device 1. The third potential VL is −5 V, for example. The fourth potential VH is +5 V, for example. The third potential VL and the fourth potential VH are supplied to the driver IC 4. The third potential VL supplied to the driver IC 4 is not limited to −5 V. The fourth potential VH supplied to the driver IC 4 is not limited to +5 V.

The control device 13 transmits a video signal Source serving as the original signal of video to be displayed on the display device 1 to the display device 1.

The control device 13 includes, for example, a central processing unit (CPU) and a storage device, such as a memory. The control device 13 can implement the display function of the display device 1 by executing computer programs using these hardware resources, such as the CPU and the storage device. The control device 13 performs control such that the driver IC 4 can handle the image to be displayed on the display device 1 as information on image input gradation according to the results of execution of the computer programs.

The display control circuit 44 controls a display operation in the display region AA by controlling the gate driver 42 and the signal line selection circuit 43. The display control circuit 44 receives the video signal Source and various control signals from the control device 13. The display control circuit 44 converts the video signal Source from the control device 13 into an image signal Vsig and outputs it. The image signal Vsig is a signal obtained by time-division multiplexing a pixel signal Sig corresponding to the RGB(W) pixel array, for example. The display control circuit 44 supplies the common potential VCOM to the common electrode COML.

The display control circuit 44 also functions as an interface (I/F) and a timing generator between the signal line selection circuit 43 and the control device 13. The driver IC 4 including the display control circuit 44 may be mounted on a relay substrate coupled to the display panel 11 instead of being mounted on the display panel 11. The gate driver 42 and the signal line selection circuit 43 may be included in the driver IC 4.

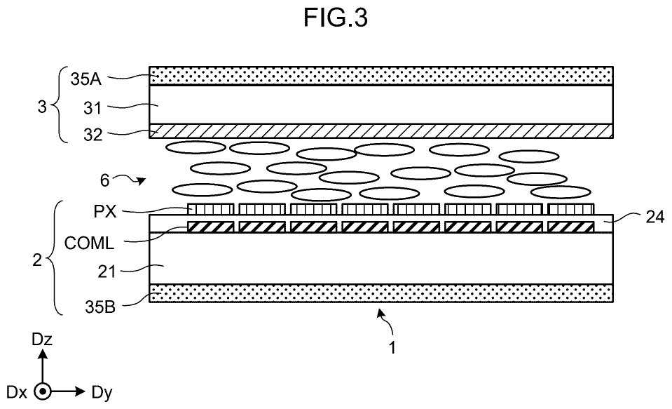

Next, a schematic configuration of the display device 1 according to the embodiment is described. FIG. 3 is a sectional view of a schematic sectional structure of the display device.

An array substrate 2 includes a first substrate 21 made of glass or transparent resin, a plurality of pixel electrodes PX, the common electrode COML, and an insulating layer 24 that insulates the pixel electrodes PX from the common electrode COML. The pixel electrodes PX are arranged in a matrix (row-column configuration), for example, on the first substrate 21. The common electrode COML is provided between the first substrate 21 and the pixel electrodes PX.

The pixel electrodes PX are provided corresponding to the respective pixels Pix. The pixel signal SIG for performing a display operation is supplied from the signal line selection circuit 43 to the pixel electrode PX via the signal line DTL and the pixel transistor Tr. In the display operation, the driver IC 4 supplies the common potential VCOM for display serving as a voltage signal to the common electrode COML. The common potential VCOM is preferably different from the GND potential and is approximately −0.08 V, for example. The common potential VCOM is set to the optimum value that does not cause flicker in the driving method, such as the column inversion driving method and the frame inversion driving method. While the common potential VCOM is preferably a fixed potential, it may have a waveform composed of AC square waves.

The pixel electrode PX and the common electrode COML are made of light-transmitting conductive material, such as indium tin oxide (ITO). A polarizing plate 35B is provided under the first substrate 21 with an adhesive layer (not illustrated) interposed therebetween.

A counter substrate 3 includes a second substrate 31 made of glass or transparent resin, and a color filter 32 and a light-shielding layer (not illustrated) formed on one surface of the second substrate 31. A polarizing plate 35A is provided on the second substrate 31 with an adhesive layer (not illustrated) interposed therebetween.

The array substrate 2 and the counter substrate 3 are disposed facing each other with a predetermined gap (cell gap) interposed therebetween. The space between the first substrate 21 and the second substrate 31 is provided with a liquid crystal layer 6 serving as a display functional layer. The liquid crystal layer 6 modulates light passing therethrough by changing the orientation state of liquid crystal molecules for each pixel Pix according to the state of the electric field between each pixel electrode PX and the common electrode COML. In the present embodiment, a liquid crystal suitable for the lateral electric field mode, such as in-plane switching (IPS) including fringe field switching (FFS), is used.

The array substrate 2 is provided with the pixel transistors Tr of the respective pixels Pix, and wiring, such as the gate lines SCL that supply the gate signals GATE for driving the pixel transistors Tr and the signal lines DTL that supply the pixel signals SIG to the pixel electrodes PX. The gate line SCL extends in the Dx direction (first direction) on a plane parallel to the surface of the first substrate 21. The signal line DTL extends in the Dy direction (second direction) on a plane parallel to the surface of the first substrate 21.

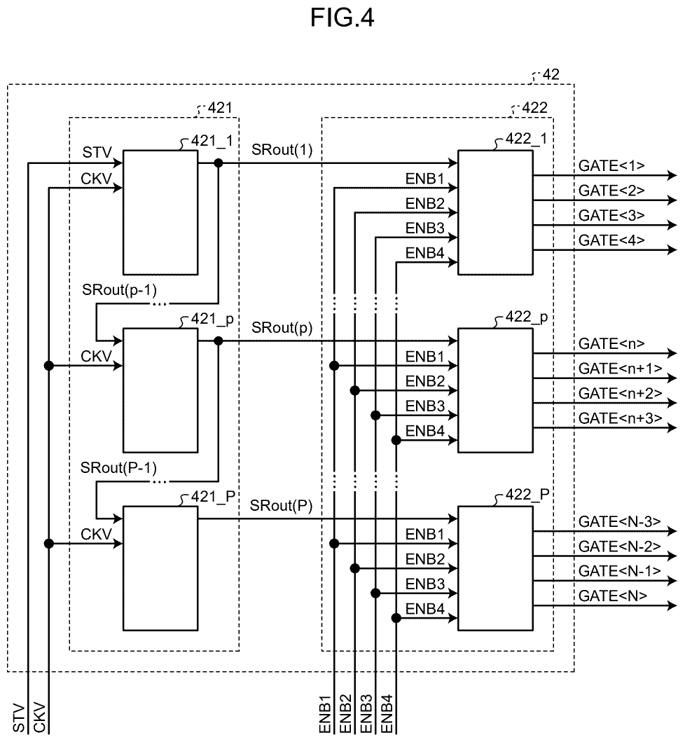

FIG. 4 is a block diagram of an example of the configuration of the gate driver. As illustrated in FIG. 4, the gate driver 42 includes a shift register circuit 421 and a gate line drive circuit 422.

The gate line drive circuit 422 is a circuit that generates the scanning signal (gate signal) GATE to be supplied to the gates of the pixel transistors Tr based on an output signal SRout output from the shift register circuit 421 and an enable signal ENB output from the display control circuit 44. The gate line drive circuit 422 includes gate line drive circuits 422_1, . . . , 422_p, . . . , and 422_P. The shift register circuit 421 includes shift register circuits 421_1, . . . , 421_p, . . . , and 421_P.

In the configuration example illustrated in FIG. 4, the total number P of gate line drive circuits 422 corresponds to ¼ of the total number N of pixels Pix arrayed in the Dy direction (second direction) (P×4=N). The gate line drive circuit 422_p (p is a natural number from 1 to P) is a circuit that drives four gate lines SCL continuously arrayed in the Dy direction (second direction). Specifically, the gate line drive circuit 422_1 supplies the gate signals GATE<1>, GATE<2>, GATE<3>, and GATE<4>. The gate line drive circuit 422_p supplies the gate signals GATE<n>, GATE<n+1>, GATE<n+2>, and GATE<n+3>. The gate line drive circuit 422_P supplies the gate signals GATE<N−3>, GATE<N−2>, GATE<N−1>, and GATE<N>. The number of gate lines SCL to which the gate line drive circuit 422_p supplies the gate signals GATE is not limited to four. When the number of gate lines SCL to which the gate line drive circuit 422_p supplies the gate signals GATE is Q, the total number P of gate line drive circuits 422 corresponds to 1/Q of the total number N of pixels Pix arrayed in the Dy direction (second direction) (P×Q=N).

In the configuration example illustrated in FIG. 4, the shift register circuits 421_1, . . . , 421_p, . . . , and 421_P are provided corresponding to the gate line drive circuits 422_1, . . . , 422_p, . . . , and 422_P, respectively. Specifically, the output signal SRout(1) of the shift register circuit 421_1 is supplied to the gate line drive circuit 422_1, the output signal SRout(p) of the shift register circuit 421_p is supplied to the gate line drive circuit 422_p, and the output signal SRout(P) of the shift register circuit 421_P is supplied to the gate line drive circuit 422_P.

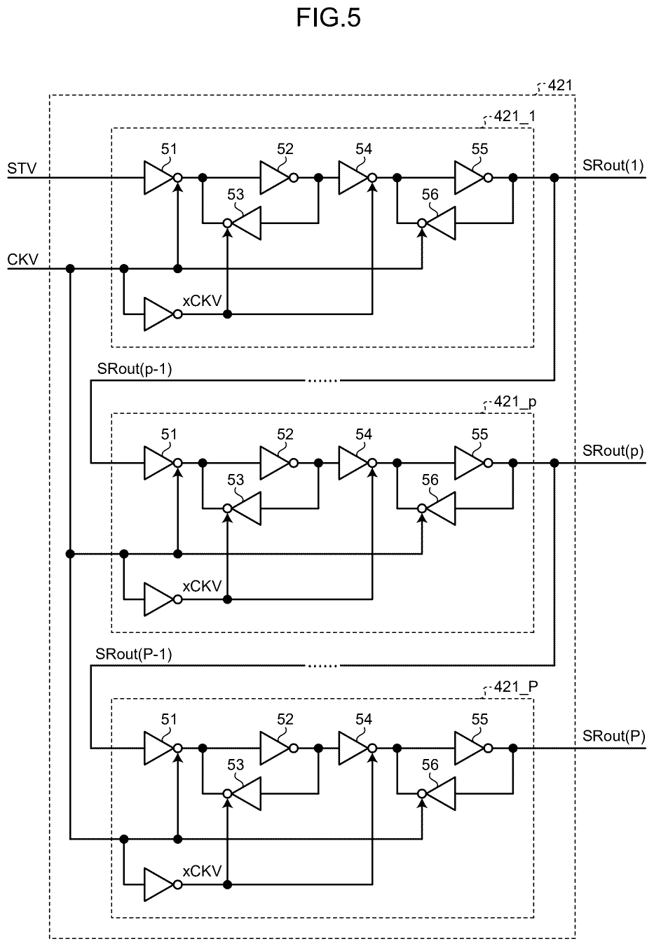

FIG. 5 is a circuit diagram of an example of the circuit configuration of the shift register circuit. The shift register circuit 421 is supplied with a start pulse signal STV and a shift clock signal CKV from the display control circuit 44.

The start pulse signal STV and the shift clock signal CKV are binary logic signals with high and low potentials.

The start pulse signal STV is a signal that defines one frame period 1F of the display device 1. Specifically, one frame period 1F of the display device 1 according to the embodiment is defined using the rising edge of the start pulse signal STV as the starting point. In other words, one frame period 1F is a period for displaying the image signals Vsig of one frame.

The shift clock signal CKV is a signal logically inverted in a predetermined period. More specifically, the shift clock signal CKV is a signal that transitions from a low potential to a high potential by defining the high potential period of the start pulse signal STV as one period.

The shift register circuit 421_1 receives the start pulse signal STV and the shift clock signal CKV. The shift register circuit 421_p receives the output signal SRout(p−1) of the previous shift register circuit 421_p−1 (not illustrated) instead of the start pulse signal STV. The shift register circuit 421_P receives the output signal SRout(P−1) of the previous shift register circuit 421_P−1 (not illustrated) instead of the start pulse signal STV.

The shift register circuits 421_1, . . . , 421_p, . . . , and 421_P each include clocked inverters 51, 53, 54, and 56 and inverters 52 and 55. The shift register circuits 421_1, . . . , 421_p, . . . , and 421_P each generate an inverted shift clock signal xCKV by logically inverting the shift clock signal CKV.

When the shift clock signal CKV is at a high potential and the inverted shift clock signal xCKV is at a low potential, the clocked inverters 51 and 56 are turned on, and the clocked inverters 53 and 54 are turned off. At this time, when the start pulse signal STV (or the output signal SRout(p−1) of the previous shift register circuit 421_p−1 (not illustrated)) is switched to a high potential, the high potential is held as the output potential of the inverter 52.

In this state, when the shift clock signal CKV is switched to a low potential and the inverted shift clock signal xCKV is switched to a high potential, the clocked inverters 51 and 56 are turned off, and the clocked inverters 53 and 54 are turned on. As a result, the high potential held as the output potential of the inverter 52 serves as the output potential of the output signal SRout(p).

When the shift clock signal CKV is at a high potential and the inverted shift clock signal xCKV is at a low potential, the clocked inverters 51 and 56 are turned on, and the clocked inverters 53 and 54 are turned off. At this time, when the start pulse signal STV (or the output signal SRout(p−1) of the previous shift register circuit 421_p−1 (not illustrated)) is switched to a low potential, the low potential is held as the output potential of the inverter 52.

In this state, when the shift clock signal CKV is switched to a low potential and the inverted shift clock signal xCKV is switched to a high potential, the clocked inverters 51 and 56 are turned off, and the clocked inverters 53 and 54 are turned on. As a result, the low potential held as the output potential of the inverter 52 serves as the output potential of the output signal SRout (p).

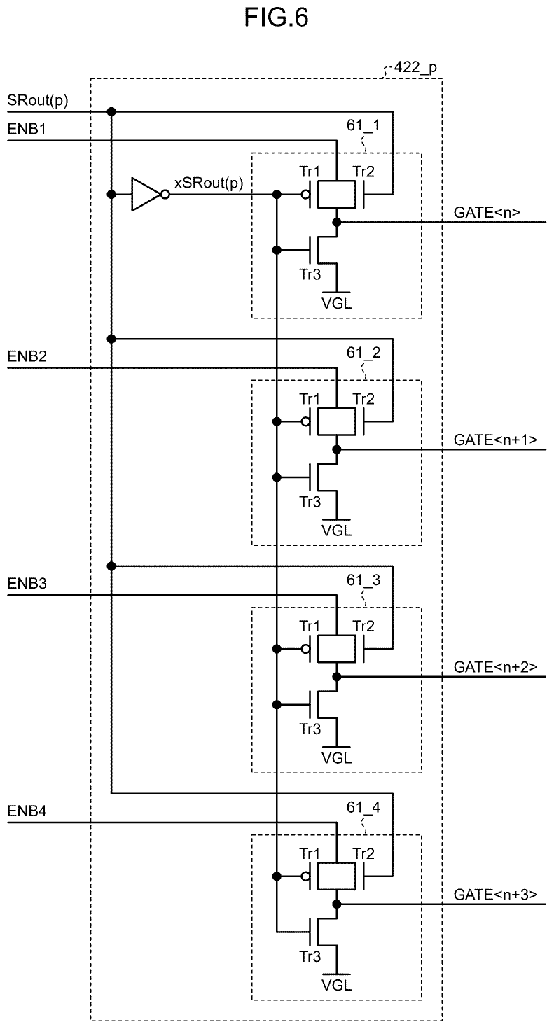

FIG. 6 is a circuit diagram of an example of the circuit configuration of the gate line drive circuit. The gate line drive circuit 422 is supplied with a first enable signal ENB1, a second enable signal ENB2, a third enable signal ENB3, and a fourth enable signal ENB4 from the display control circuit 44.

The gate line drive circuit 422_1 receives the output signal SRout(1) of the shift register circuit 421_1. The gate line drive circuit 422_p receives the output signal SRout(p) of the shift register circuit 421_p. The gate line drive circuit 422_P receives the output signal SRout(P) of the shift register circuit 421_P.

The following describes the configuration of the gate line drive circuit 422_p. The gate line drive circuit 422_p generates an inverted output signal xSRout(p) by logically inverting the output signal SRout(p) output from the shift register circuit 421_p.

The gate line drive circuit 422_p includes a first buffer circuit 61_1, a second buffer circuit 61_2, a third buffer circuit 61_3, and a fourth buffer circuit 61_4. The first buffer circuit 61_1 generates the gate signal GATE<n> to be supplied to the pixels Pix arrayed in the Dx direction (first direction) on the n-th row in the Dy direction (second direction). The second buffer circuit 61_2 generates the gate signal GATE<n+1> to be supplied to the pixels Pix arrayed in the Dx direction (first direction) on the n+1-th row in the Dy direction (second direction). The third buffer circuit 61_3 generates the gate signal GATE<n+2> to be supplied to the pixels Pix arrayed in the Dx direction (first direction) on the n+2-th row in the Dy direction (second direction). The fourth buffer circuit 61_4 generates the gate signal GATE<n+3> to be supplied to the pixels Pix arrayed in the Dx direction (first direction) on the n+3-th row in the Dy direction (second direction).

In the first buffer circuit 61_1, when the output signal SRout(p) output from the shift register circuit 421_p is at a low potential (first potential VGL), a first transistor Tr1 and a second transistor Tr2 are turned off, and a third transistor Tr3 is turned on. As a result, the output potential of the first buffer circuit 61_1 is the first potential VGL, and the pixel transistors Tr of the pixels Pix arrayed in the Dx direction (first direction) on the n-th row in the Dy direction (second direction) are turned off.

In the first buffer circuit 61_1, when the output signal SRout(p) output from the shift register circuit 421_p is at a high potential (second potential VGH), the first transistor Tr1 and the second transistor Tr2 are turned on, and the third transistor Tr3 is turned off. As a result, the output potential of the first buffer circuit 61_1 is a potential (e.g., the second potential VGH) dependent on the potential of the first enable signal ENB1, and the pixel transistors Tr of the pixels Pix arrayed in the Dx direction (first direction) on the n-th row in the Dy direction (second direction) are turned on.

In the second buffer circuit 61_2, when the output signal SRout(p) output from the shift register circuit 421_p is at a low potential (first potential VGL), the first transistor Tr1 and the second transistor Tr2 are turned off, and the third transistor Tr3 is turned on. As a result, the output potential of the second buffer circuit 61_2 is the first potential VGL, and the pixel transistors Tr of the pixels Pix arrayed in the Dx direction (first direction) on the n+1-th row in the Dy direction (second direction) are turned off.

In the second buffer circuit 61_2, when the output signal SRout(p) output from the shift register circuit 421_p is at a high potential (second potential VGH), the first transistor Tr1 and the second transistor Tr2 are turned on, and the third transistor Tr3 is turned off. As a result, the output potential of the second buffer circuit 61_2 is a potential (e.g., the second potential VGH) dependent on the potential of the second enable signal ENB2, and the pixel transistors Tr of the pixels Pix arrayed in the Dx direction (first direction) on the n+1-th row in the Dy direction (second direction) are turned on.

In the third buffer circuit 61_3, when the output signal SRout(p) output from the shift register circuit 421_p is at a low potential (first potential VGL), the first transistor Tr1 and the second transistor Tr2 are turned off, and the third transistor Tr3 is turned on. As a result, the output potential of the third buffer circuit 61_3 is the first potential VGL, and the pixel transistors Tr of the pixels Pix arrayed in the Dx direction (first direction) on the n+2-th row in the Dy direction (second direction) are turned off.

In the third buffer circuit 61_3, when the output signal SRout(p) output from the shift register circuit 421_p is at a high potential (second potential VGH), the first transistor Tr1 and the second transistor Tr2 are turned on, and the third transistor Tr3 is turned off. As a result, the output potential of the third buffer circuit 61_3 is a potential (e.g., the second potential VGH) dependent on the potential of the third enable signal ENB3, and the pixel transistors Tr of the pixels Pix arrayed in the Dx direction (first direction) on the n+2-th row in the Dy direction (second direction) are turned on.

In the fourth buffer circuit 61_4, when the output signal SRout(p) output from the shift register circuit 421_p is at a low potential (first potential VGL), the first transistor Tr1 and the second transistor Tr2 are turned off, and the third transistor Tr3 is turned on. As a result, the output potential of the fourth buffer circuit 61_4 is the first potential VGL, and the pixel transistors Tr of the pixels Pix arrayed in the Dx direction (first direction) on the n+3-th row in the Dy direction (second direction) are turned off.

In the fourth buffer circuit 61_4, when the output signal SRout(p) output from the shift register circuit 421_p is at a high potential (second potential VGH), the first transistor Tr1 and the second transistor Tr2 are turned on, and the third transistor Tr3 is turned off. As a result, the output potential of the fourth buffer circuit 61_4 is a potential (e.g., the second potential VGH) dependent on the potential of the fourth enable signal ENB4, and the pixel transistors Tr of the pixels Pix arrayed in the Dx direction (first direction) on the n+3-th row in the Dy direction (second direction) are turned on.

### First Embodiment

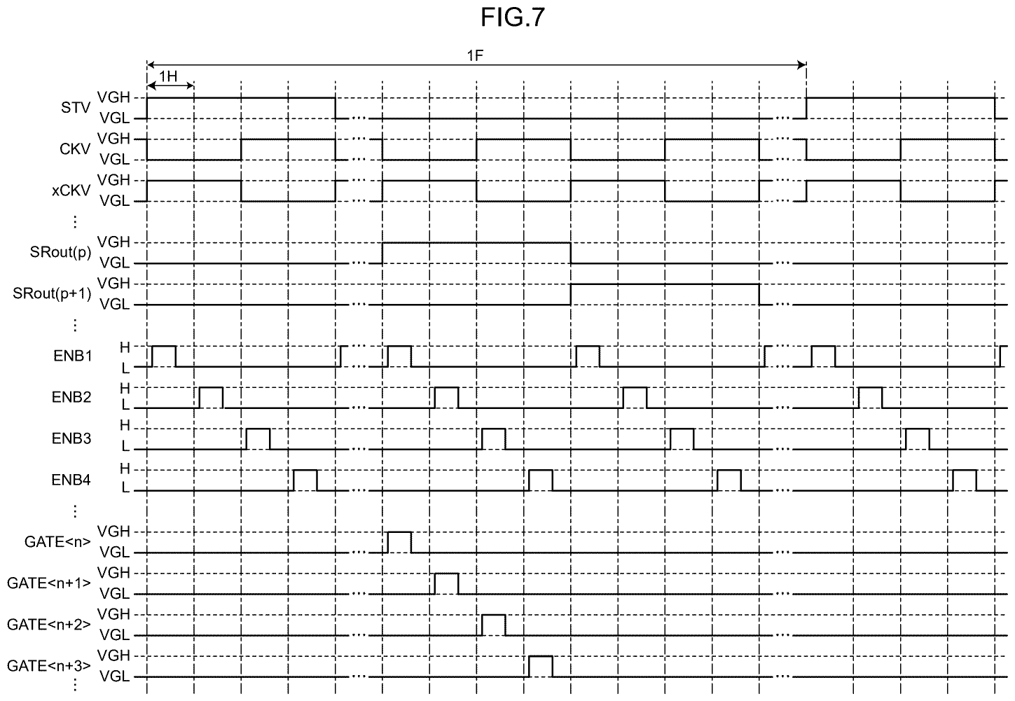

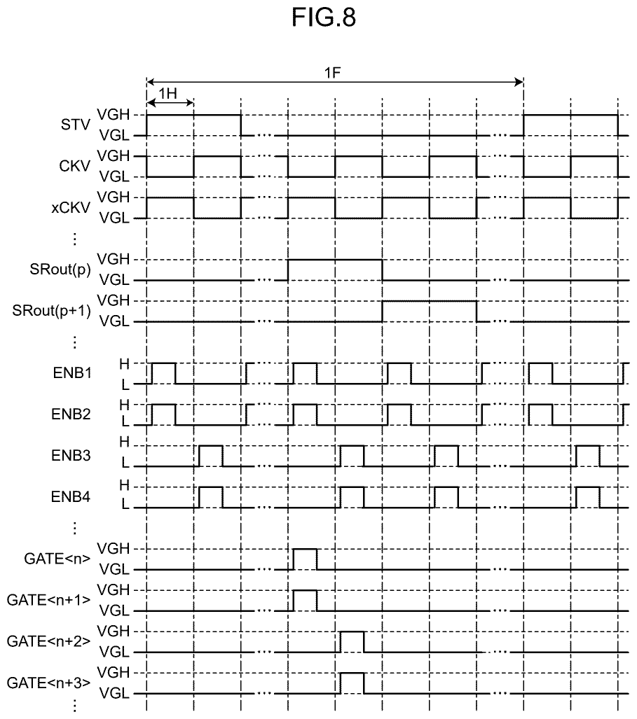

FIG. 7 is a timing chart of a first example of gate line drive according to a first comparative example. FIG. 8 is a timing chart of a second example of gate line drive according to the first comparative example.

In the first example of gate line drive according to the first comparative example illustrated in FIG. 7, the pixels Pix coupled to the gate lines SCL arrayed in the Dy direction (second direction) are sequentially driven in the respective horizontal periods 1H. In the second example of gate line drive according to the first comparative example illustrated in FIG. 8, the pixels Pix coupled to two gate lines SCL arrayed in the Dy direction (second direction) are simultaneously driven in one horizontal period 1H.

More specifically, in FIG. 8, the gate signal GATE<n> and the gate signal GATE<n+1> are simultaneously switched from a low potential (first potential VGL) to a high potential (second potential VGH) in one horizontal period in the first half of two horizontal periods when the output signal SRout(p) output from the shift register circuit 421_p is at a high potential (second potential VGH). As a result, the pixel transistors Tr of the pixels Pix arrayed in the Dx direction (first direction) on the n-th row in the Dy direction (second direction) and the pixel transistors Tr of the pixels Pix arrayed in the Dx direction (first direction) on the n+1-th row in the Dy direction (second direction) are simultaneously turned on.

In FIG. 8, the gate signal GATE<n> and the gate signal GATE<n+1> are simultaneously switched from the high potential (second potential VGH) to the low potential (first potential VGL) in one horizontal period in the first half of the two horizontal periods when the output signal SRout(p) output from the shift register circuit 421_p is at a high potential (second potential VGH). As a result, the pixel transistors Tr of the pixels Pix arrayed in the Dx direction (first direction) on the n-th row in the Dy direction (second direction) and the pixel transistors Tr of the pixels Pix arrayed in the Dx direction (first direction) on the n+1-th row in the Dy direction (second direction) are simultaneously turned off.

The gate signal GATE<n+2> and the gate signal GATE<n+3> are simultaneously switched from a low potential (first potential VGL) to a high potential (second potential VGH) in one horizontal period in the second half of the two horizontal periods when the output signal SRout(p) output from the shift register circuit 421_p is at a high potential (second potential VGH). As a result, the pixel transistors Tr of the pixels Pix arrayed in the Dx direction (first direction) on the n+2-th row in the Dy direction (second direction) and the pixel transistors Tr of the pixels Pix arrayed in the Dx direction (first direction) on the n+3-th row in the Dy direction (second direction) are simultaneously turned on.

In FIG. 8, the gate signal GATE<n+2> and the gate signal GATE<n+3> are simultaneously switched from the high potential (second potential VGH) to the low potential (first potential VGL) in one horizontal period in the second half of the two horizontal periods when the output signal SRout(p) output from the shift register circuit 421_p is at a high potential (second potential VGH). As a result, the pixel transistors Tr of the pixels Pix arrayed in the Dx direction (first direction) on the n+2-th row in the Dy direction (second direction) and the pixel transistors Tr of the pixels Pix arrayed in the Dx direction (first direction) on the n+3-th row in the Dy direction (second direction) are simultaneously turned off.

With this configuration, the second example can achieve a higher frame rate than that of the first example illustrated in FIG. 7. Specifically, the drive mode in the second example illustrated in FIG. 8 can make the frame rate approximately twice the frame rate in the first example illustrated in FIG. 7.

In the display device 1 with the schematic structure described above, not only the holding capacitance Cs formed between the pixel electrode PX and the common electrode COML but also parasitic capacitance is generated between the pixel electrode PX and other conductive members. Specifically, as illustrated in FIG. 2, parasitic capacitances Cgs1 and Cgs2 are generated between the pixel electrode PX and each of two gate lines SCL that sandwich the pixel transistor Tr in the Dy direction (second direction). As a result, a decrease in potential by what is called a feedthrough phenomenon occurs in the pixel electrode PX due to charge redistribution in the holding capacitance Cs in a gate-off state.

In the following description, the pixels Pix arrayed in the Dx direction (first direction) on the n-th row in the Dy direction (second direction) are also referred to as “first pixels”. In the present disclosure, the gate line coupled to the gates of the pixel transistors Tr of the first pixels corresponds to a “first gate line”.

The pixels Pix arrayed in the Dx direction (first direction) on the n+1-th row in the Dy direction (second direction) are also referred to as “second pixels”. In the present disclosure, the gate line coupled to the gates of the pixel transistors Tr of the second pixels corresponds to a “second gate line”.

The parasitic capacitance Cgs1 generated between the pixel electrode PX and the gate line SCL on the upper side of each pixel Pix illustrated in FIG. 2 is also referred to as “first parasitic capacitance Cgs1”. The parasitic capacitance Cgs2 generated between the pixel electrode PX and the gate line SCL on the lower side of each pixel Pix illustrated in FIG. 2 is also referred to as “second parasitic capacitance Cgs2”.

In the drive mode in the first example of gate line drive according to the first comparative example illustrated in FIG. 7, a feedthrough voltage ΔV is expressed by the following Expression (1) using the first potential VGL, a potential Vd of the pixel signal SIG<m>, the holding capacitance Cs, the first parasitic capacitance Cgs1, and the second parasitic capacitance Cgs2.

$$Δ V = ( Vd - VGL ) \times Cgs 1 / ( Cgs 1 + Cgs 2 + Cs ) \qquad ( 1 )$$

The capacitance values of the first parasitic capacitance Cgs1 and the second parasitic capacitance Cgs2 are approximately 1/100 of the holding capacitance Cs. The relation between the capacitance value Cgs1 of the first parasitic capacitance and the capacitance value Cgs2 of the second parasitic capacitance typically satisfies Cgs1>Cgs2.

In the drive mode in the first example of gate line drive according to the first comparative example illustrated in FIG. 7, the feedthrough voltages generated in the first pixel and the second pixel can both be expressed by the Expression (1) above.

By contrast, in the drive mode in the second example of gate line drive according to the first comparative example illustrated in FIG. 8, the first pixel and the second pixel have a difference in feedthrough voltage. Specifically, the feedthrough voltage ΔV generated in the second pixel is expressed by the Expression (1) above as in the drive mode in the first example of gate line drive according to the first comparative example illustrated in FIG. 7. By contrast, the feedthrough voltage ΔV generated in the first pixel is expressed by the following Expression (2).

$$Δ V = ( Vd - VGL ) \times ( Cgs 1 + Cgs 2 ) / ( Cgs 1 + Cgs 2 + Cs ) \qquad ( 2 )$$

This causes a potential difference in pixel electrode potential between the first pixel and the second pixel that are simultaneously driven, which may possibly deteriorate the display quality.

In an example of gate line drive according to a first embodiment, when simultaneously driving the first pixel and the second pixel arrayed in the Dy direction (second direction), the pixel transistor of the second pixel is turned off before the pixel transistor of the first pixel is turned off. This configuration can suppress the potential difference in pixel electrode potential between the first pixel and the second pixel that are simultaneously driven.

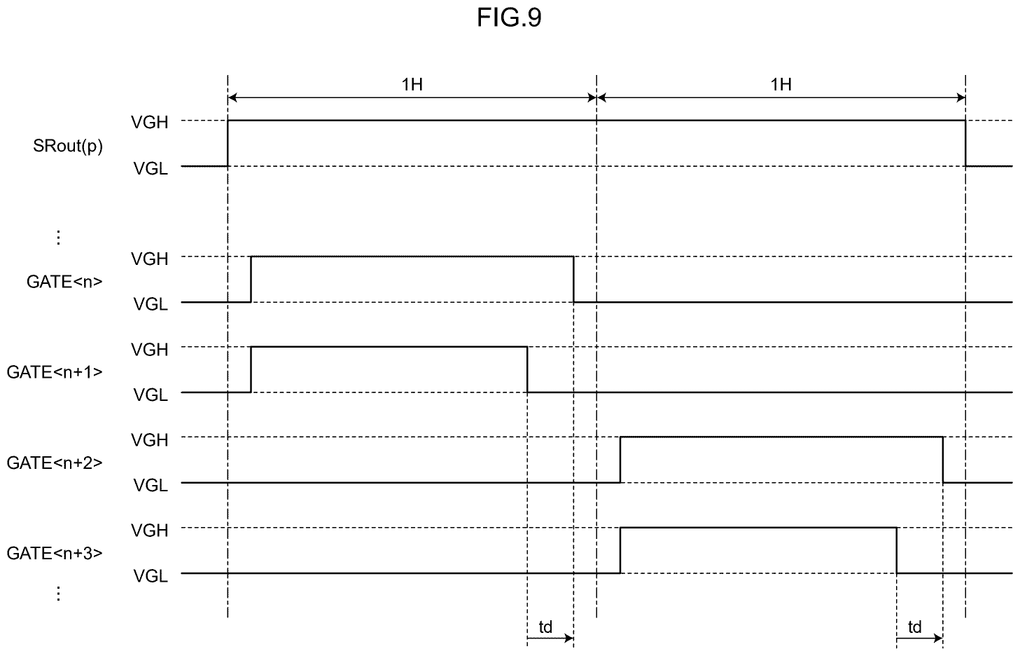

FIG. 9 is a timing chart of the example of gate line drive according to the first embodiment. Specifically, as illustrated in FIG. 9, the gate driver 42 according to the first embodiment simultaneously controls the gate signal GATE<n> and the gate signal GATE<n+1> from a low potential (first potential VGL) to a high potential (second potential VGH) in one horizontal period 1H in the first half of two horizontal periods when the output signal SRout(p) output from the shift register circuit 421_p is at a high potential (second potential VGH). Subsequently, the gate driver 42 sequentially controls the gate signal GATE<n+1> and the gate signal GATE<n> in this order from the high potential (second potential VGH) to the low potential (first potential VGL).

In FIG. 9, after the gate driver 42 controls the gate signal GATE<n+1> from the high potential (second potential VGH) to the low potential (first potential VGL), a delay time td elapses before the gate driver 42 controls the gate signal GATE<n> from the high potential (second potential VGH) to the low potential (first potential VGL).

The gate driver 42 simultaneously controls the gate signal GATE<n+2> and the gate signal GATE<n+3> from a low potential (first potential VGL) to a high potential (second potential VGH) in one horizontal period 1H in the second half of the two horizontal periods when the output signal SRout(p) output from the shift register circuit 421_p is at a high potential (second potential VGH). Subsequently, the gate driver 42 sequentially controls the gate signal GATE<n+3> and the gate signal GATE<n+2> in this order from the high potential (second potential VGH) to the low potential (first potential VGL).

In FIG. 9, after the gate driver 42 controls the gate signal GATE<n+3> from the high potential (second potential VGH) to the low potential (first potential VGL), the delay time td elapses before the gate driver 42 controls the gate signal GATE<n+2> from the high potential (second potential VGH) to the low potential (first potential VGL).

As a result, the feedthrough voltage generated in the pixel Pix supplied with the gate signal GATE<n>, the feedthrough voltage generated in the pixel Pix supplied with the gate signal GATE<n+1>, the feedthrough voltage generated in the pixel Pix supplied with the gate signal GATE<n+2>, and the feedthrough voltage generated in the pixel Pix supplied with the gate signal GATE<n+3> are all expressed by Expression (1) above as in the drive mode in the first example of gate line drive according to the first comparative example illustrated in FIG. 7. Therefore, the first embodiment can suppress deterioration in display quality due to charge redistribution in the holding capacitance in a gate-off state.

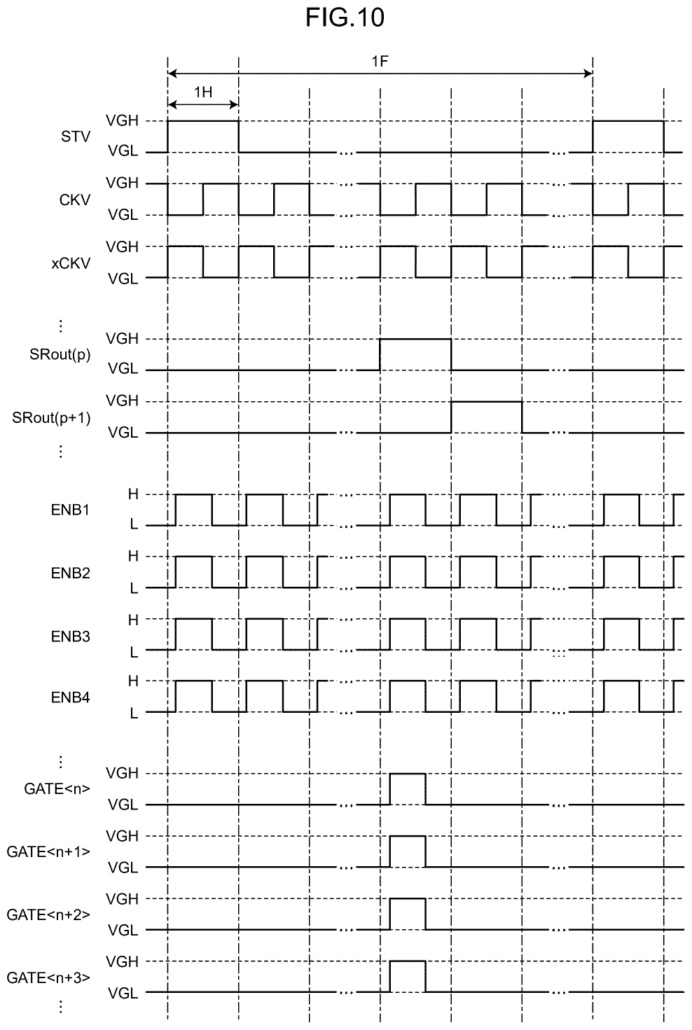

FIG. 10 is a timing chart of a third example of gate line drive according to the first comparative example. In the third example of gate line drive according to the first comparative example illustrated in FIG. 10, the pixels Pix coupled to four gate lines SCL arrayed in the Dy direction (second direction) are simultaneously driven in one horizontal period 1H.

More specifically, in FIG. 10, the gate signal GATE<n>, the gate signal GATE<n+1>, the gate signal GATE<n+2>, and the gate signal GATE<n+3> are simultaneously switched to a high potential (second potential VGH) in one horizontal period when the output signal SRout(p) output from the shift register circuit 421_p is at a high potential (second potential VGH). As a result, the pixel transistors Tr of the pixels Pix arrayed in the Dx direction (first direction) on the n-th row in the Dy direction (second direction), the pixel transistors Tr of the pixels Pix arrayed in the Dx direction (first direction) on the n+1-th row in the Dy direction (second direction), the pixel transistors Tr of the pixels Pix arrayed in the Dx direction (first direction) on the n+2-th row in the Dy direction (second direction), and the pixel transistors Tr of the pixels Pix arrayed in the Dx direction (first direction) on the n+3-th row in the Dy direction (second direction) are simultaneously turned on.

In FIG. 10, in one horizontal period when the output signal SRout(p) output from the shift register circuit 421_p is at a high potential (second potential VGH), the gate signal GATE<n>, the gate signal GATE<n+1>, the gate signal GATE<n+2>, and the gate signal GATE<n+3> are simultaneously switched from the high potential (second potential VGH) to the low potential (first potential VGL). As a result, the pixel transistors Tr of the pixels Pix arrayed in the Dx direction (first direction) on the n-th row in the Dy direction (second direction), the pixel transistors Tr of the pixels Pix arrayed in the Dx direction (first direction) on the n+1-th row in the Dy direction (second direction), the pixel transistors Tr of the pixels Pix arrayed in the Dx direction (first direction) on the n+2-th row in the Dy direction (second direction), and the pixel transistors Tr of the pixels Pix arrayed in the Dx direction (first direction) on the n+3-th row in the Dy direction (second direction) are simultaneously turned off.

With this configuration, the third example can achieve a higher frame rate than that of the second example of gate line drive according to the first comparative example illustrated in FIG. 8. Specifically, the drive mode in the third example of gate line drive according to the first comparative example illustrated in FIG. 10 can make the frame rate approximately four times the frame rate in the first example of gate line drive according to the first comparative example illustrated in FIG. 7 and approximately twice the frame rate in the second example of gate line drive according to the first comparative example illustrated in FIG. 8.

In the following description, the pixels Pix arrayed in the Dx direction (first direction) on the n-th row in the Dy direction (second direction) are also referred to as “first pixels”. In the present disclosure, the gate line coupled to the gates of the pixel transistors Tr of the first pixels corresponds to a “first gate line”.

The pixels Pix arrayed in the Dx direction (first direction) on the n+1-th row in the Dy direction (second direction) are also referred to as “second pixels”. In the present disclosure, the gate line coupled to the gates of the pixel transistors Tr of the second pixels corresponds to a “second gate line”.

The pixels Pix arrayed in the Dx direction (first direction) on the n+2-th row in the Dy direction (second direction) are also referred to as “third pixels”. In the present disclosure, the gate line coupled to the gates of the pixel transistors Tr of the third pixels corresponds to a “third gate line”.

The pixels Pix arrayed in the Dx direction (first direction) on the n+3-th row in the Dy direction (second direction) are also referred to as “fourth pixels”. In the present disclosure, the gate line coupled to the gates of the pixel transistors Tr of the fourth pixels corresponds to a “fourth gate line”.

In an example of gate line drive according to a modification of the first embodiment, when simultaneously driving the first pixel, the second pixel, the third pixel, and the fourth pixel arrayed in the Dy direction (second direction), the pixel transistor of the second pixel is turned off before the pixel transistor of the first pixel is turned off, the pixel transistor of the third pixel is turned off before the pixel transistor of the second pixel is turned off, and the pixel transistor of the fourth pixel is turned off before the pixel transistor of the third pixel is turned off. This configuration can suppress the potential difference in pixel electrode potential between the first pixel, the second pixel, the third pixel, and the fourth pixel that are simultaneously driven.

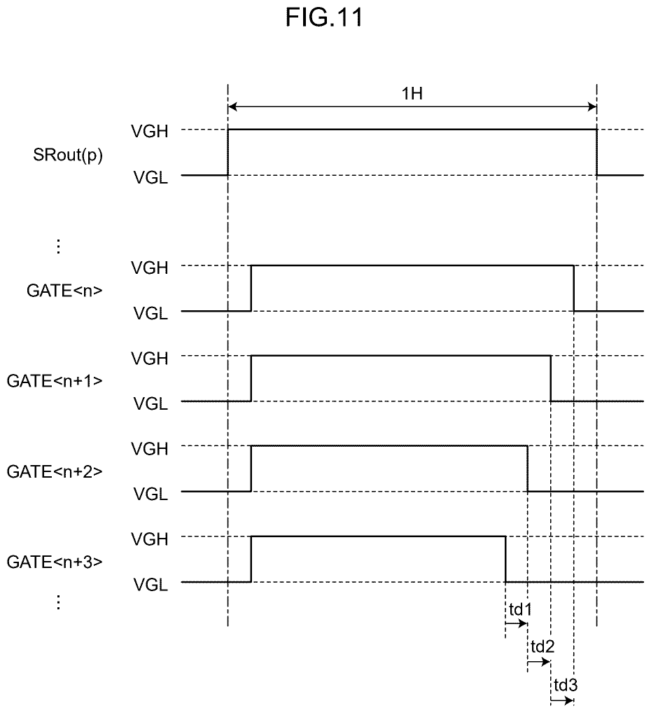

FIG. 11 is a timing chart of the example of gate line drive according to the modification of the first embodiment. Specifically, as illustrated in FIG. 11, the gate driver 42 according to the modification of the first embodiment simultaneously controls the gate signal GATE<n>, the gate signal GATE<n+1>, the gate signal GATE<n+2>, and the gate signal GATE<n+3> from a low potential (first potential VGL) to a high potential (second potential VGH) in one horizontal period 1H when the output signal SRout(p) output from the shift register circuit 421_p is at a high potential (second potential VGH). Subsequently, the gate driver 42 sequentially controls the gate signal GATE<n+3>, the gate signal GATE<n+2>, the gate signal GATE<n+1>, and the gate signal GATE<n> in this order from the high potential (second potential VGH) to the low potential (first potential VGL).

In FIG. 11, after the gate driver 42 controls the gate signal GATE<n+3> from the high potential (second potential VGH) to the low potential (first potential VGL), a delay time td1 elapses before the gate driver 42 controls the gate signal GATE<n+2> from the high potential (second potential VGH) to the low potential (first potential VGL). After the gate driver 42 controls the gate signal GATE<n+2> from the high potential (second potential VGH) to the low potential (first potential VGL), a delay time td2 elapses before the gate driver 42 controls the gate signal GATE<n+1> from the high potential (second potential VGH) to the low potential (first potential VGL). After the gate driver 42 controls the gate signal GATE<n+1> from the high potential (second potential VGH) to the low potential (first potential VGL), a delay time td3 elapses before the gate driver 42 controls the gate signal GATE<n> from the high potential (second potential VGH) to the low potential (first potential VGL).

As a result, similarly to the first embodiment, the feedthrough voltage generated in the pixel Pix supplied with the gate signal GATE<n>, the feedthrough voltage generated in the pixel Pix supplied with the gate signal GATE<n+1>, the feedthrough voltage generated in the pixel Pix supplied with the gate signal GATE<n+2>, and the feedthrough voltage generated in the pixel Pix supplied with the gate signal GATE<n+3> are all expressed by Expression (1) above as in the drive mode in the first example of gate line drive according to the first comparative example illustrated in FIG. 7. Therefore, the modification of the first embodiment can suppress deterioration in display quality due to charge redistribution in the holding capacitance in a gate-off state.

### Second Embodiment

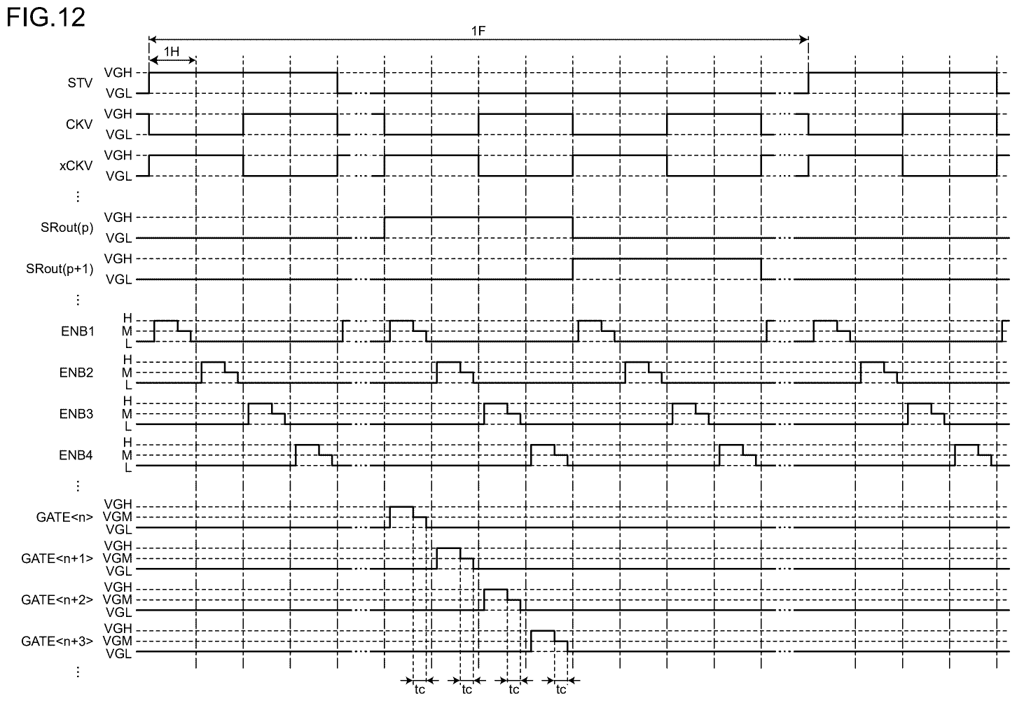

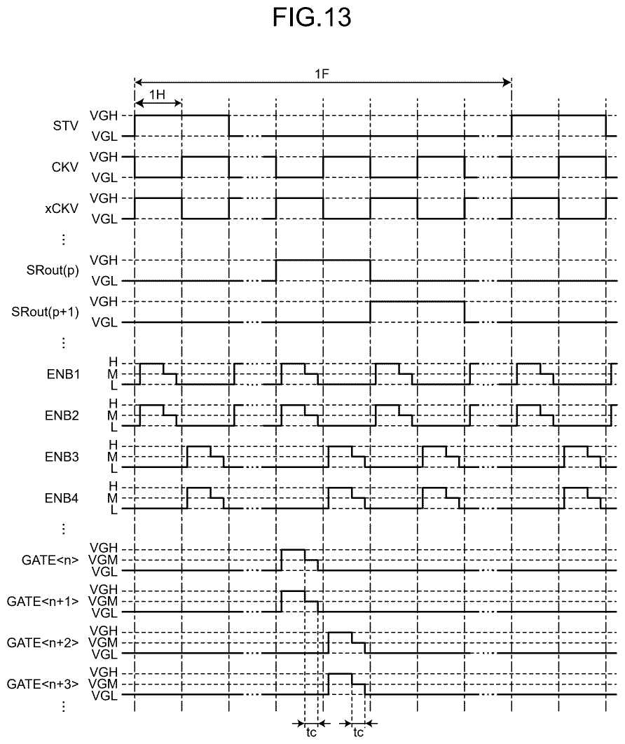

FIG. 12 is a timing chart of a first example of gate line drive according to a second comparative example. FIG. 13 is a timing chart of a second example of gate line drive according to the second comparative example.

In the first example of gate line drive according to the second comparative example illustrated in FIG. 12, the pixels Pix coupled to the gate lines SCL arrayed in the Dy direction (second direction) are sequentially driven in the respective horizontal periods 1H as in the first example of gate line drive according to the first comparative example illustrated in FIG. 7. In the second example of gate line drive according to the second comparative example in FIG. 13, the pixels Pix coupled to two gate lines SCL arrayed in the Dy direction (second direction) are simultaneously driven in one horizontal period 1H as in the second example of gate line drive according to the first comparative example illustrated in FIG. 8.

In the first example of gate line drive according to the second comparative example illustrated in FIG. 12 and the second example of gate line drive according to the second comparative example illustrated in FIG. 13, after the gate signal GATE is controlled from a low potential (first potential VGL) to a high potential (second potential VGH), the gate signal GATE is controlled to an intermediate potential (third potential VGM) between the low potential (first potential VGL) and the high potential (second potential VGH) (period tc illustrated in FIGS. 12 and 13). Subsequently, the gate signal GATE is controlled from the intermediate potential (third potential VGM) to the low potential (first potential VGL). The intermediate potential (third potential VGM) is the GND potential, for example. This configuration can suppress transitional potential fluctuations due to charge redistribution in the holding capacitance Cs in a gate-off state.

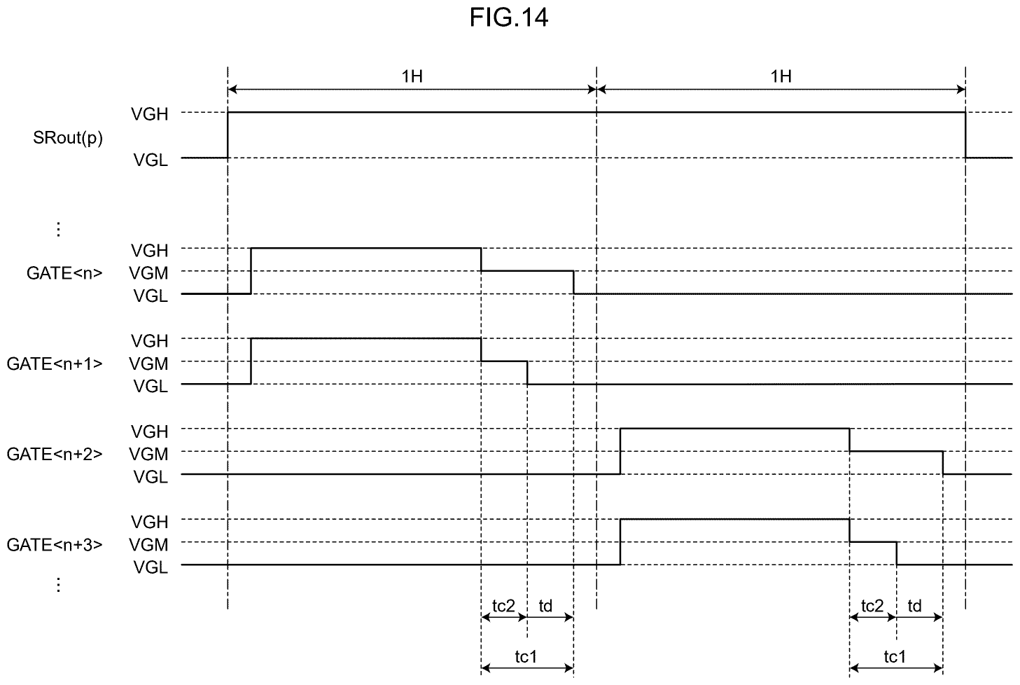

FIG. 14 is a timing chart of an example of gate line drive according to a second embodiment. Specifically, as illustrated in FIG. 14, the gate driver 42 according to the second embodiment simultaneously controls the gate signal GATE<n> and the gate signal GATE<n+1> from a low potential (first potential VGL) to a high potential (second potential VGH) in one horizontal period 1H in the first half of two horizontal periods when the output signal SRout(p) output from the shift register circuit 421_p is at a high potential (second potential VGH). Subsequently, the gate driver 42 simultaneously controls the gate signal GATE<n> and the gate signal GATE<n+1> from the high potential (second potential VGH) to an intermediate potential (third potential VGM) (periods tc1 and tc2 illustrated in FIG. 14). Subsequently, the gate driver 42 sequentially controls the gate signal GATE<n+1> and the gate signal GATE<n> in this order from the intermediate potential (third potential VGM) to the low potential (first potential VGL).

In FIG. 14, after the gate driver 42 controls the gate signal GATE<n+1> from the intermediate potential (third potential VGM) to the low potential (first potential VGL), the delay time td elapses before the gate driver 42 controls the gate signal GATE<n> from the intermediate potential (third potential VGM) to the low potential (first potential VGL).

The gate driver 42 simultaneously controls the gate signal GATE<n+2> and the gate signal GATE<n+3> from a low potential (first potential VGL) to a high potential (second potential VGH) in one horizontal period 1H in the second half of the two horizontal periods when the output signal SRout(p) output from the shift register circuit 421_p is at a high potential (second potential VGH). Subsequently, the gate driver 42 simultaneously controls the gate signal GATE<n+2> and the gate signal GATE<n+3> from the high potential (second potential VGH) to an intermediate potential (third potential VGM). Subsequently, the gate driver 42 sequentially controls the gate signal GATE<n+3> and the gate signal GATE<n+2> in this order from the intermediate potential (third potential VGM) to the low potential (first potential VGL).

In FIG. 14, after the gate driver 42 controls the gate signal GATE<n+3> from the intermediate potential (third potential VGM) to the low potential (first potential VGL), the delay time td elapses before the gate driver 42 controls the gate signal GATE<n+2> from the intermediate potential (third potential VGM) to the low potential (first potential VGL).

As a result, similarly to the first embodiment, the feedthrough voltage generated in the pixel Pix supplied with the gate signal GATE<n>, the feedthrough voltage generated in the pixel Pix supplied with the gate signal GATE<n+1>, the feedthrough voltage generated in the pixel Pix supplied with the gate signal GATE<n+2>, and the feedthrough voltage generated in the pixel Pix supplied with the gate signal GATE<n+3> are all expressed by Expression (1) above as in the drive mode in the first example of gate line drive according to the first comparative example illustrated in FIG. 7. Therefore, the second embodiment can suppress deterioration in display quality due to charge redistribution in the holding capacitance in a gate-off state.

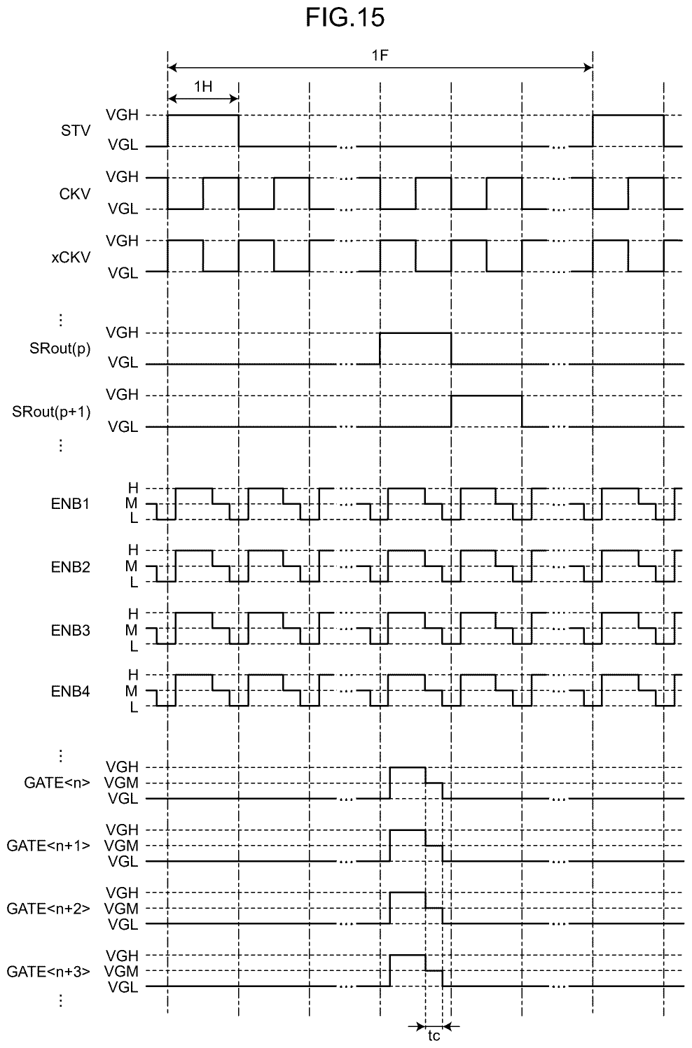

FIG. 15 is a timing chart of a third example of gate line drive according to the second comparative example. In the third example of gate line drive according to the second comparative example in FIG. 15, the pixels Pix coupled to four gate lines SCL arrayed in the Dy direction (second direction) are simultaneously driven in one horizontal period 1H as in the third example of gate line drive according to the first comparative example illustrated in FIG. 10.

In the third example of gate line drive according to the second comparative example illustrated in FIG. 15, after the gate signal GATE is controlled from the low potential (first potential VGL) to the high potential (second potential VGH), the gate signal GATE is controlled to the intermediate potential (third potential VGM) between the low potential (first potential VGL) and the high potential (second potential VGH) (period tc illustrated in FIG. 15). Subsequently, the gate signal GATE is controlled from the intermediate potential (third potential VGM) to the low potential (first potential VGL) as in the first example of gate line drive according to the second comparative example illustrated in FIG. 12 and the second example of gate line drive according to the second comparative example illustrated in FIG. 13. The intermediate potential (third potential VGM) is the GND potential, for example. This configuration can suppress transitional potential fluctuations due to charge redistribution in the holding capacitance Cs in a gate-off state.

More specifically, in FIG. 15, the gate signal GATE<n>, the gate signal GATE<n+1>, the gate signal GATE<n+2>, and the gate signal GATE<n+3> are simultaneously switched to a high potential (second potential VGH) in one horizontal period when the output signal SRout(p) output from the shift register circuit 421_p is at a high potential (second potential VGH). As a result, the pixel transistors Tr of the pixels Pix arrayed in the Dx direction (first direction) on the n-th row in the Dy direction (second direction), the pixel transistors Tr of the pixels Pix arrayed in the Dx direction (first direction) on the n+1-th row in the Dy direction (second direction), the pixel transistors Tr of the pixels Pix arrayed in the Dx direction (first direction) on the n+2-th row in the Dy direction (second direction), and the pixel transistors Tr of the pixels Pix arrayed in the Dx direction (first direction) on the n+3-th row in the Dy direction (second direction) are simultaneously turned on.

In FIG. 15, in one horizontal period when the output signal SRout(p) output from the shift register circuit 421_p is at a high potential (second potential VGH), the gate signal GATE<n>, the gate signal GATE<n+1>, the gate signal GATE<n+2>, and the gate signal GATE<n+3> are simultaneously switched from the intermediate potential (third potential VGM) to the low potential (first potential VGL). As a result, the pixel transistors Tr of the pixels Pix arrayed in the Dx direction (first direction) on the n-th row in the Dy direction (second direction), the pixel transistors Tr of the pixels Pix arrayed in the Dx direction (first direction) on the n+1-th row in the Dy direction (second direction), the pixel transistors Tr of the pixels Pix arrayed in the Dx direction (first direction) on the n+2-th row in the Dy direction (second direction), and the pixel transistors Tr of the pixels Pix arrayed in the Dx direction (first direction) on the n+3-th row in the Dy direction (second direction) are simultaneously turned off.

With this configuration, the third example can achieve a higher frame rate than that of the second example of gate line drive according to the second comparative example illustrated in FIG. 13. Specifically, the drive mode in the third example of gate line drive according to the second comparative example illustrated in FIG. 15 can make the frame rate approximately four times the frame rate in the first example of gate line drive according to the second comparative example illustrated in FIG. 12 and approximately twice the frame rate in the second example of gate line drive according to the second comparative example illustrated in FIG. 13.

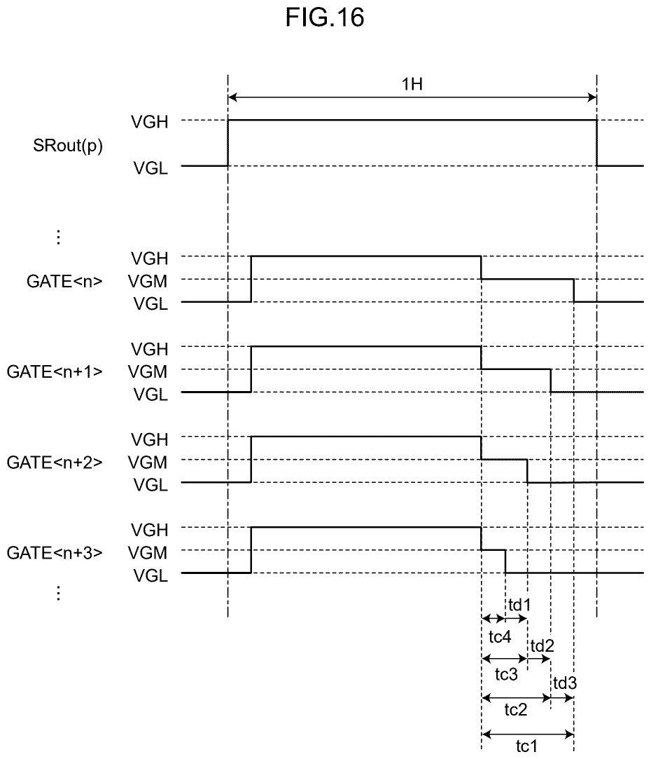

FIG. 16 is a timing chart of an example of gate line drive according to a modification of the second embodiment. Specifically, as illustrated in FIG. 16, the gate driver 42 according to the modification of the second embodiment simultaneously controls the gate signal GATE<n>, the gate signal GATE<n+1>, the gate signal GATE<n+2>, and the gate signal GATE<n+3> from a low potential (first potential VGL) to a high potential (second potential VGH) in one horizontal period 1H when the output signal SRout(p) output from the shift register circuit 421_p is at a high potential (second potential VGH). Subsequently, the gate driver 42 simultaneously controls the gate signal GATE<n>, the gate signal GATE<n+1>, the gate signal GATE<n+2>, and the gate signal GATE<n+3> from the high potential (second potential VGH) to an intermediate potential (third potential VGM) (periods tc1, tc2, tc3, and tc4 illustrated in FIG. 16). Subsequently, the gate driver 42 sequentially controls the gate signal GATE<n+3>, the gate signal GATE<n+2>, the gate signal GATE<n+1>, and the gate signal GATE<n> in this order from the intermediate potential (third potential VGM) to the low potential (first potential VGL).

In FIG. 16, after the gate driver 42 controls the gate signal GATE<n+3> from the intermediate potential (third potential VGM) to the low potential (first potential VGL), the delay time td1 elapses before the gate driver 42 controls the gate signal GATE<n+2> from the intermediate potential (third potential VGM) to the low potential (first potential VGL). After the gate driver 42 controls the gate signal GATE<n+2> from the intermediate potential (third potential VGM) to the low potential (first potential VGL), the delay time td2 elapses before the gate driver 42 controls the gate signal GATE<n+1> from the intermediate potential (third potential VGM) to the low potential (first potential VGL). After the gate driver 42 controls the gate signal GATE<n+1> from the intermediate potential (third potential VGM) to the low potential (first potential VGL), the delay time td3 elapses before the gate driver 42 controls the gate signal GATE<n> from the intermediate potential (third potential VGM) to the low potential (first potential VGL).

As a result, similarly to the modification of the first embodiment, the feedthrough voltage generated in the pixel Pix supplied with the gate signal GATE<n>, the feedthrough voltage generated in the pixel Pix supplied with the gate signal GATE<n+1>, the feedthrough voltage generated in the pixel Pix supplied with the gate signal GATE<n+2>, and the feedthrough voltage generated in the pixel Pix supplied with the gate signal GATE<n+3> are all expressed by Expression (1) above as in the drive mode in the first example of gate line drive according to the first comparative example illustrated in FIG. 7. Therefore, the modification of the second embodiment can suppress deterioration in display quality due to charge redistribution in the holding capacitance in a gate-off state.

The display device 1 is not limited to a liquid crystal display device and may be an organic EL display including organic light-emitting diodes (OLED) as display elements, for example. Alternatively, the display device 1 may be an inorganic EL display including inorganic light-emitting diodes (micro LED) as the display elements. Still alternatively, the display device 1 may be an electrophoretic display (EPD) or a transparent display that displays images on a transmissive display surface.

While the embodiments above have described the examples where two or four gate lines SCL arrayed in the Dy direction (second direction) are simultaneously driven, the number of gate lines simultaneously driven is not limited to two or four. Furthermore, the number of gate lines SCL simultaneously driven may be changed depending on the position in the Dy direction (second direction).

While the exemplary embodiment of the present disclosure has been described, the embodiment is not intended to limit the present disclosure. The contents disclosed in the embodiment are given by way of example only, and various modifications may be made without departing from the spirit of the present disclosure. Appropriate modifications made without departing from the spirit of the present disclosure naturally fall within the technical scope of the present disclosure.

What is claimed is:

1. A display device comprising:
a plurality of first pixels arrayed in a first direction;
a plurality of second pixels arrayed in the first direction and adjacent to the respective first pixels in a second direction intersecting the first direction;
a first gate line coupled to a gate of a pixel transistor of each of the first pixels;
a second gate line coupled to a gate of a pixel transistor of each of the second pixels;
a drive circuit configured to drive the pixel transistor of the first pixel via the first gate line and drive the pixel transistor of the second pixel via the second gate line; and
a display region in which the first gate line, the pixel transistor of the first pixel, the second gate line, and the pixel transistor of the second pixel are arrayed in order in the second direction, wherein
the drive circuit simultaneously turns on the pixel transistor of the first pixel and the pixel transistor of the second pixel, and then sequentially turns off the pixel transistor of the second pixel and the pixel transistor of the first pixel in order.

2. The display device according to claim 1, wherein the drive circuit simultaneously controls the first gate line and the second gate line from a first potential to a second potential higher than the first potential, and then sequentially controls the second gate line and the first gate line in order from the second potential to the first potential.

3. The display device according to claim 1, wherein the drive circuit simultaneously controls the first gate line and the second gate line from a first potential to a second potential higher than the first potential, then simultaneously controls the first gate line and the second gate line from the second potential to a third potential lower than the second potential and higher than the first potential, and then sequentially controls the second gate line and the first gate line in order from the third potential to the first potential.

4. A display device comprising:
a plurality of first pixels arrayed in a first direction;
a plurality of second pixels arrayed in the first direction and adjacent to the respective first pixels in a second direction intersecting the first direction;
a plurality of third pixels arrayed in the first direction and adjacent to the respective second pixels in the second direction;
a first gate line coupled to a gate of a pixel transistor of each of the first pixels;
a second gate line coupled to a gate of a pixel transistor of each of the second pixels;
a third gate line coupled to a gate of a pixel transistor of each of the third pixels;
a drive circuit configured to drive the pixel transistor of the first pixel via the first gate line, drive the pixel transistor of the second pixel via the second gate line, and drive the pixel transistor of the third pixel via the third gate line; and
a display region in which the first gate line, the pixel transistor of the first pixel, the second gate line, the pixel transistor of the second pixel, the third gate line, and the pixel transistor of the third pixel are arrayed in order in the second direction, wherein
the drive circuit simultaneously turns on the pixel transistor of the first pixel, the pixel transistor of the second pixel, and the pixel transistor of the third pixel, and then sequentially turns off the pixel transistor of the third pixel, the pixel transistor of the second pixel, and the pixel transistor of the first pixel in order.

5. The display device according to claim 4, wherein the drive circuit simultaneously controls the first gate line, the second gate line, and the third gate line from a first potential to a second potential higher than the first potential, and then sequentially controls the third gate line, the second gate line, and the first gate line in order from the second potential to the first potential.

6. The display device according to claim 4, wherein the drive circuit simultaneously controls the first gate line, the second gate line, and the third gate line from a first potential to a second potential higher than the first potential, then simultaneously controls the first gate line, the second gate line, and the third gate line from the second potential to a third potential lower than the second potential and higher than the first potential, and then sequentially controls the third gate line, the second gate line, and the first gate line in order from the third potential to the first potential.
